(19) United States
(12) Patent Application Publication
(10) Pub. No.: US 2025/0313041 A1
(43) Pub. Date: Oct. 9, 2025

(54) TIRE COMPOSITIONS COMPRISING FUNCTIONALIZED RUBBERS BASED ON ETHYLENE-COPOLYMERS

(71) Applicant: ARLANXEO DEUTSCHLAND GMBH, Dormagen (DE)

(72) Inventors: Kilian Nikolaus Richard WUEST, Dormagen (DE); Raffaele BERNARDO, Maastricht (NL)

(73) Assignee: ARLANXEO DEUTSCHLAND GMBH, Dormagen (DE)

(21) Appl. No.: 18/864,975

(22) PCT Filed: May 3, 2023
(86) PCT No.: PCT/EP2023/061660

§ 371 Date: Nov. 12, 2024

(30) Foreign Application Priority Data
May 12, 2022 (EP) 22172950.2

(51) Int. Cl. B60C 1/00; C08F 255/04; C08J 3/20; C08K 3/04; C08K 3/06; C08K 3/22; C08K 3/36; C08K 5/01; C08K 5/09; C08L 9/06

(52) U.S. Cl. CPC B60C 1/0016; C08F 255/04; C08J 3/203; C08K 3/04; C08K 3/06; C08K 3/36; C08K 5/01; C08K 5/09; C08L 9/06; C08J 2309/06; C08K 2003/2296; C08L 2205/03

(57) ABSTRACT

Use of an ethylene copolymer for making tire or tire tread compounds, wherein the ethylene-copolymer is a copolymer comprising units derived from ethylene and at least one alpha-olefin monomer having from 3 to 12 carbon atoms, preferably propylene and, optionally, having units derived from at least one non-conjugated diene, and wherein the ethylene copolymer is functionalized to have at least one functional group comprising at least one polar unit selected from a carboxylic acid group (or salts thereof), an anhydride group, an epoxy group, a glycidyl ether group or a combination thereof, and wherein the ethylene-copolymer comprises from 40 to 80% wt. of units derived from ethylene, preferably from 44% wt. to 76% wt. of units derived from ethylene and at least 20% wt. of units derived from one or one alpha-olefin monomer having from 3 to 12 carbon atoms, preferably comprising at least 15% wt. of units derived from propylene. Also provided are compositions comprising the ethylene-copolymer and a conjugated diene polymer, method of making such compositions and articles containing them.

### BACKGROUND

Synthetic rubbers are used in many different applications. They are typically combined with one or more fillers to produce rubber compounds which are then shaped into articles or combined with other ingredients to produce articles. A major application of synthetic rubbers includes tires or components of tires such as tire treads. Typical conjugated diene rubbers are homopolymers of conjugated dienes or copolymers of at least one conjugated diene monomer are used for this purpose.

There is a continuous need to improve the properties of tires and in particular the properties of tire treads. It has now been found that rubbers based on ethylene copolymers can be used advantageously for making tires or tire treads.

### SUMMARY

Therefore in one aspect there is provided a use of an ethylene copolymer for making tire or tire tread compounds, wherein the ethylene-copolymer is a copolymer comprising units derived from ethylene and at least one alpha-olefin monomer having from 3 to 12 carbon atoms, preferably propylene and, optionally, having units derived from at least one non-conjugated diene, and wherein the ethylene copolymer is functionalized to have at least one functional group comprising at least one polar unit selected from a carboxylic acid group (or salts thereof), an anhydride group, an epoxy group, a glycidyl ether group or a combination thereof, and wherein the ethylene-copolymer comprises from 40 to 80% wt. of units derived from ethylene, preferably from 44% wt. to 76% wt. of units derived from ethylene and at least 20% wt. of units derived from one or one alpha-olefin monomer having from 3 to 12 carbon atoms, preferably comprising at least 15% wt. of units derived from propylene.

In another aspect there is provided a composition comprising (i) at least one functionalized ethylene-copolymer and (ii) at least one conjugated diene polymer wherein the conjugated diene polymer is a homopolymer of a conjugated diene or a copolymer of at least one conjugated diene, and wherein the conjugated diene is selected from the group consisting of butadiene, isoprene, 1,3-pentadiene, 2,3-dimethylbutadiene, 1-phenyl-1,3-butadiene, 1,3-hexadiene, preferably butadiene, and wherein the conjugated diene polymer is either non-functionalized or functionalized.

In a further aspect there is provided a method of making a curable composition comprising combining the ethylene-copolymer with a conjugated diene polymer and at least one curative capable of curing at least the conjugated diene polymer.

In yet another aspect there is provided an article obtained by a process comprising curing a composition comprising (i) the functionalized ethylene-copolymer and (ii) the conjugated diene polymer wherein the process comprises at least one shaping step wherein the shaping may take place prior to, during or after the curing.

### DETAILED DESCRIPTION

In the following description the terms “comprising”, “containing”, “including”, “having” are intended to have an open meaning and may or may not include the presence of any additional ingredient, component, step or procedure.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber, i.e., the weight percentage based on the total amount of rubber which is set to 100.

Ranges identified in this disclosure include and disclose all values between the endpoints of the range and include the end points unless stated otherwise.

The term “substituted” is used to describe hydrocarbon-containing organic compounds where at least one hydrogen atom has been replaced by a chemical entity other than a hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

### Ethylene Copolymer

The functionalized ethylene copolymer can be prepared by methods as known in the art. There is no particular limitation for synthesizing the polymer except that the polymer has at least one functional group. The ethylene copolymer may be prepared by using polymerization catalysts such as catalysts of the Ziegler Natta type, metallocene catalysts and post metallocene catalysts. Preferably, the ethylene copolymer comprises from 40 to 80% wt. of units derived from ethylene, more preferably from 44% wt. to 76% wt. of units derived from ethylene. The polymer can be linear or branched.

The functional group may be at a terminal position of the polymer or as part of the polymer chain or as part of a side chain. Preferably, the functional group is part of the polymer chain or part of a side chain, and, preferably, the polymer comprises a plurality of functional groups, which may be identical or different.

Suitable functional groups include groups having, or consisting of, at least one polar unit selected from anhydrides, epoxy groups, glycidyl ether groups, carboxylic acid groups and combinations thereof. Preferred polar units include carboxylic acid groups, including monocarboxylic acid groups and bicarboxylic acid groups, and anhydride groups. Preferred polar units include a monocarboxylic acid group or salt thereof, a bicarboxylic acid group or salt thereof, an anhydride group or a combination thereof. In one embodiment of the present disclosure the ethylene copolymer comprises from 0.001 to 20% wt., preferably from 0.001 to 10% wt., more preferably from 0.3 to 5% wt. of polar units based on the total weight of the polymer.

The at least one functional group may be introduced, for example, by grafting or by copolymerization using an olefinic functionalization agent. Suitable olefinic functionalizing agents comprise at least one carbon-carbon double bond and carries at least one polar unit as described above. The olefinic functionalizing agents also include polymerizable oligomers with up to 100 units derived from a monomer. Preferred olefinic functionalizing agents include but are not limited to glycidylmethacrylate; allyl glycidyl ether, allyl glycidyl ester, acrylic acid, methacrylic acid, vinyl acetate, cinnamic acid, crotonic acid, maleic acid, fumaric acid, itaconic acid, citraconic acid, glutaconic acid, maleic anhydride, itaconic anhydride, citraconic anhydride, glutaconic anhydride including salts thereof and derivatives thereof where one or more hydrocarbon groups bear a substituent instead of a hydrogen atom and wherein the substituent is selected from a halogen, a C₁-C₆ alkyl, a C₁-C₆ halogenated alkyl, a C₂-C₆ alkenyl, a C₂-C₆ halogenated alkenyl, a C₁-C₆ hydroxy alkyl, a C₂-C₆ hydroxy alkenyl, a C₁-C₆ alkyl ether or a C₂-C₆ alkenylether or polyether, i.e. an alkyl or alkenyl with one or more than one catenary oxygen ether atoms, and combinations thereof. Preferably, the ethylene-copolymer comprises from 0.001 to 20% wt., preferably from 0.001 to 10% wt., more preferably from 0.3 to 5% wt., based on the total weight of the polymer, of functional groups derived from one or more olefinic functional agent.

Preferably, the ethylene-copolymer has one or more functional groups according to formulae (1), (2) or a combination thereof:

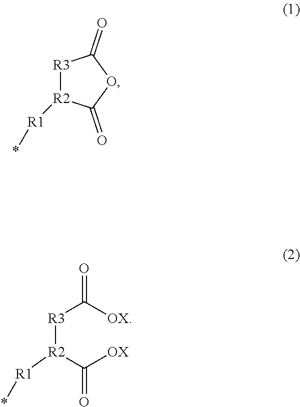

In formula (1) R1 represents a chemical bond or a C₁-C₆ alkyl, a C₁-C₆ halogenated alkyl, a C₁-C₆ hydroxy alkyl, a C₁-C₆ alkyl ether or polyether. R2 represents a —CH₂— group of which one hydrogen atom, optionally, may be substituted with a halogen, a C₁-C₆ alkyl, a C₁-C₆ halogenated alkyl, a C₁-C₆ hydroxy alkyl, a C₁-C₆ alkyl ether or polyether. R3 is a —CH₂— group of which one hydrogen atom, optionally, may be substituted with a halogen, a C₁-C₆ alkyl, a C₁-C₆ halogenated alkyl, a C₁-C₆ hydroxy alkyl, a C₁-C₆ alkyl ether or polyether. The * indicates the connection to the polymer backbone. X represents H or a cation.

In a preferred embodiment of the present disclosure the ethylene-copolymer comprises one or more functional groups according to formulae (3)-(5):

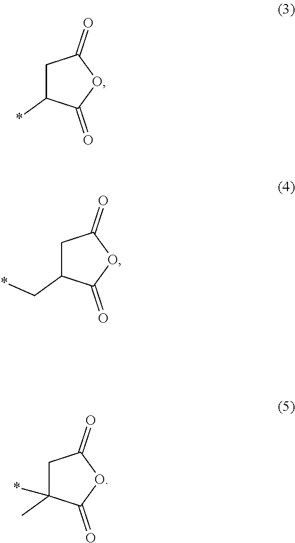

Preferably, the ethylene copolymer comprises from 0.001 to 20% wt., preferably from 0.001 to 10% wt., more preferably from 0.3 to 5% wt., based on the total weight of the polymer, of functional groups, preferably of functional groups according to formulae (1)-(5).

In one embodiment of the present disclosure the functionalized polymers may be obtained, for example, by grafting, for example by reactive extrusion with one or more olefinic functionalizing agent. Such a process is described for example, in US patent application US2010/0113315A1. The process may comprise heating the ethylene-copolymer to a molten condition, for example at a temperature in the range of 60° C. to 240° C., and grafting, in an extruder or mixing device, the olefinic functionalizing agent onto the polymer, preferably in the presence of a radical initiator. The olefinic functionalizing agent and free-radical initiator are separately co-fed to the molten polymer to effect grafting. The radical initiators which may be used to graft the olefinic functionalizing agents onto the ethylene-copolymer include, but are not limited to, peroxides, hydroperoxides, peresters and azo compounds and preferably those which decompose thermally to a substantial extent within the grafting temperature range and time to provide free radicals. Representatives of these free-radical initiators include azobutyronitrile, dicumyl peroxide, 2,5-dimethylhexane-2,5-bis-tertiarybutyl peroxide, 2,5-dimethylhex-3-yne-2,5-bis-tertiary-butyl peroxide and di-tertiarybutyl peroxide. The initiator may be used in an amount of between about 0.005% and about 1% by weight based on the weight of the reaction mixture.

Other methods known in the art for effecting reaction of ethylene-copolymers with olefinic functionalizing agents, such as halogenation reactions, thermal or “ene” reactions or mixtures thereof, can be used instead of the free-radical grafting process. Such reactions are conveniently carried out in mineral oil or bulk by heating the reactants at temperatures of 60° C. to 240° C. under an inert atmosphere to avoid the generation of free radicals and oxidation byproducts.

The functionalized polymers may also be obtained by using olefinic functionalizing agents as comonomers during the polymerization reaction to produce the ethylene-copolymer. The polymerization may be carried out to produce a random polymer or a block copolymer where the olefinic functionalizing agents may be used as one or more than one blocks, for example at the beginning, the middle or the end of the polymer. The olefinic functionalizing agents may also be introduced as oligomers, for example after having been polymerized with itself, prior to or during or after the addition of the monomers for producing the ethylene-copolymer.

Preferably, the ethylene copolymer comprises at least 5 wt % of units derived from one or more comonomer. The comonomers may be suitable olefinic functionalizing agents as described above, for example (meth)acrylic acids and their derivatives, or they may be other comonomers that are non-functionalized. Suitable non-functionalized comonomers include but are not limited to hydrocarbon alpha olefins having from 3 to 12 carbon atoms, preferably propylene.

In one embodiment the copolymer has at least 20% by weight of units derived from one or more alpha-olefin comonomer and, preferably, has at least 20% by weight of units derived from propylene.

In addition, the ethylene copolymer may comprise units derived from one or more non-conjugated diene monomers that introduce unsaturations, i.e. —C═C— double bonds, into the polymer that may be available for a curing reaction. Suitable comonomers include non-conjugated diene monomers selected from polyenes comprising at least two double bonds, the double bonds being non-conjugated in chains, rings, ring systems or combinations thereof. The polyenes may have endocyclic and/or exocyclic double bonds and may have no, the same or different types of substituents. The double bonds are at least separated by two carbon atoms. To a significant extent only one of the non-conjugated double bonds is converted by a polymerization catalyst. The non-conjugated dienes are preferably aliphatic, more preferably alicyclic and aliphatic. Suitable non-conjugated dienes include aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, dicyclopentadiene, and mixtures thereof. Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Preferred examples include dicyclopentadiene, 5-methylene-2-norbornene and 5-ethylidene-2-norbornene (ENB) with ENB being particularly preferred.

Examples of aromatic non-conjugated polyenes include vinylbenzene (including its isomers) and vinyl-isopropenylbenzene (including its isomers).

The copolymer may comprise from 0.01 to 10% by weight of units derived from one or more of non-conjugated diene monomers.

In one embodiment the copolymer comprises from units derived from ethylene and at least one or more alpha-olefins and from 0 to 10% by weight of units of one or more other comonomers, and in embodiment the copolymer does not comprise any non-conjugated diene monomers.

Preferably, the ethylene copolymer has a melt flow index (2.16 kg/190° C.) of from about 0.5 to 150 g/10 min, preferably from about 1 to about 120 g/10 min.

In one embodiment the ethylene copolymer has a molecular weight (Mw) from 10 to 300 kg/mol or a number averaged molecular weight (Mn) of from 10 to 100 kg/mol or a combination thereof. In one embodiment the ethylene copolymer has a ratio of Mw/Mn of from about 1.2 to 10.

Suitable commercial functionalized ethylene copolymers include, but are not limited to KELTAN 2706R, KELTAN 0512R or KELTAN 1519R, available from ARLANXEO Netherlands B.V.

The functionalized ethylene copolymer is preferably used in combination with the at least one conjugated diene polymer in a weight ratio of ethylene copolymer to conjugated diene polymer of 1:2 to 1:20, or from 1:3 to 1:12. In one embodiment the composition additionally comprises one or more NdBRs.

### Conjugated Diene Polymers

The diene polymers according to the present disclosure may be functionalized or non-functionalized polymers.

The conjugated diene polymers according to the present disclosure can be obtained by a polymerization reaction comprising the polymerization of at least one conjugated diene as monomer. Preferably, the diene polymer is a homopolymer or a copolymer of at least one conjugated diene, preferably selected from 1,3-butadiene, isoprene, 1,3-pentadiene, 2,3-dimethylbutadiene, 1-phenyl-1,3-butadiene, 1,3-hexadiene. 1,3-Butadiene and/or isoprene are particularly preferred.

In one embodiment of the present disclosure the diene polymer is a polybutadiene homopolymer, more preferably a 1,3-butadiene homopolymer. In another embodiment of the present disclosure the diene polymer is a 1,3-butadiene-copolymer.

In another embodiment of the present disclosure the diene polymer is a copolymer of a conjugated diene, preferably butadiene, wherein the copolymer comprises units derived from one or more conjugated diene as described above and/or one or more vinyl aromatic monomer, and, optionally, one or more units derived from one or more other comonomers. Examples of vinylaromatic monomers include, but are not limited to, styrene, ortho-methyl styrene, meta-methyl styrene, para-methyl styrene, para-tertbutyl styrene, vinyl naphthalene, and combinations thereof. Styrene is particularly preferred.

The vinylaromatic monomers also include substituted vinyl aromatic monomers where one or more hydrogen atoms of the vinyl aromatic monomer have been replaced by a heteroatom or groups having one or more heteroatoms, preferably selected from Si, N, O, H, Cl, F, Br, S and combinations thereof. Substituted monomers also include vinyl aromatic monomers having one or more functional groups with one or more heteroatoms or units containing at least one functional group with one or more heteroatom. Preferably, the heteroatoms are selected from Si, N, O, H, Cl, F, Br, S and combinations thereof. Examples of functional groups include but are not limited to hydroxy, thiol, thioether, ether, halogen carboxylic acid groups or salt thereof and combinations thereof. Such functionalized conjugated monomers are preferably copolymerized with one or more of the vinylaromatic monomers described above.

In a preferred embodiment the diene polymer according to the present disclosure comprises repeating units derived from 1,3-butadiene and styrene.

Preferably, the polymers according to the present disclosure contain at least 50% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene. In one embodiment the polymer according to the present disclosure comprises at least 75% or at least 95% by weight of units derived from one or more than conjugated diene monomers.

In one embodiment of the present disclosure the diene polymers contain from 0 to 49% by weight, or from 0% to 40% by weight, based on the total weight of the polymer, of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain at least 50% by weight, preferably at least 60% by weight, based on the weight of the polymer, of units derived from 1,3-butadiene and at least 5% by weight, and preferably up to 49% by weight, of units derived from one or more vinyl aromatic comonomer, preferably from 5% to 40% by weight, or from 10% to 35% by weight, of units derived from one or more vinyl aromatic comonomer, preferably a styrene. Optionally, such polymers may comprise from 0 to 25% by weight of one or more other comonomer with the proviso that the total amount of monomers is adjusted such that the polymer still has a total weight of 100%. In one embodiment the polymer according to the present disclosure comprises from 55% to 92% by weight of units derived from one or more conjugated diene monomers and from 5.8% to 45% by weight of units derived from vinyl aromatic comonomers.

Suitable other conjugated dienes as comonomer include but are not limited to myrcene, ocimenes and/or farnesenes. The conjugated dienes also include substituted conjugated dienes, where one or more hydrogen atoms of the diene have been replaced by groups containing one or more heteroatoms selected from Si, N, O, H, Cl, F, Br, S and combinations thereof or functional groups containing one or more heteroatoms, for example functional groups having one or more heteroatoms selected from Si, N, O, H, Cl, F, Br, S and combinations. Examples of functional groups include but are not limited to hydroxy, thiol, thioether, ether, halogen, amine, silane and units having one or more carboxylic acid groups or salts thereof and combinations thereof. Such functionalized conjugated dienes are preferably copolymerized with one or more of the conjugated dienes described above.

Suitable copolymerizable comonomers further include one or more alpha-olefins, for example, ethene, propene, 1-butene, 1-pentene, 1-hexene, 4-methyl-1-pentene, 1-octene and combinations thereof. In one embodiment, the diene polymers according to the present disclosure contain from 0 to 20% by weight of units derived from one or more alpha-olefins.

Suitable comonomers also include, but are not limited to, one or more other co-polymerizable comonomers that introduce functional groups—other than the functional comonomers above-including cross-linking sites, branching sites, branches or functionalized groups. In one embodiment of the present disclosure the diene polymers contain from 0% to 10% by weight or from 0% to 5% by weight of units derived from one or more of such other comonomers. Such comonomers include, for example, divinyl benzene, trivinyl benzene, divinyl naphthalene.

Combinations of one or more of comonomers of the same chemical type as described above as well as combinations of one or more comonomers from different chemical types may be used. In one embodiment of the present disclosure the other comonomers described above are absent or the polymer comprises less than 10% by weight, less than 5% by weight or not more than 1% by weight of units derived from them.

The diene polymers according to the present disclosure preferably have an average molecular weight (number average, Mn) of 10,000 to 2,000,000 g/mol, preferably of 100,000 to 1,000,000 g/mol.

Preferably, the diene polymers according to the present disclosure have a glass transition temperature (Tg) of from about −110° C. to about +20° C., preferably of from about −110° C. to about 0° C.

Preferably, the diene polymers according to the present disclosure have a Mooney viscosity [ML 1+4 (100° C.)] of from about 10 to about 200, preferably from about 30 to about 150 Mooney units.

The polymers typically have a dispersity from about 1.03 to about 3.5.

The diene polymers can be prepared by methods known in the art. Preferably the polymers can be obtained by a process comprising an anionic solution polymerization or a polymerization using one or more coordination catalysts. The polymerization may be carried out in solution or in the gas phase. Coordination catalysts include Ziegler-Natta catalysts or monometallic catalyst systems. Preferred coordination catalysts are those based on Ni, Co, Ti, Zr, Nd, V, Cr, Mo, W or Fe.

In one embodiment the conjugated diene polymer is not functionalized. In another embodiment the conjugated diene polymer is functionalized. In one embodiment the composition comprises a combination of at least one non-functionalized and at least functionalized conjugated diene polymer.

### Functionalized Conjugated Dienes

The functionalized conjugated diene polymers can be prepared, for example, by a reaction involving the addition of at least one functionalization agent to reactive polymer chains produced by a polymerization of conjugated monomers and may be followed by the addition of at least one further functionalization agent as known in the art.

Preferably, the diene polymer is functionalized by one or more appropriate functionalization agents to create a terminal or a side group comprising at least one functional group comprising at least one silane or siloxane unit, preferably comprising from 1 to 20 silicon atoms in addition to carbon, hydrogen and, optionally, oxygen atoms and, optionally may further comprise one or more heteroatoms selected from N and S. Preferably, the functional group comprises at least one terminal unit comprising at least one group selected from the groups —COOX; —OX; —SX, —OR; —COOR, wherein X represent hydrogen or a cation and R represents a C₁ to C₂₀-alkyl, preferably a C₁ to C₁₂ alkyl.

In one embodiment of the present disclosure the second functional group is obtainable by adding a silicic compound or a cyclic urea, or an alkylene oxide, or a combination thereof to the polymerization reaction. Preferably the reaction product is treated to at least one terminal unit selected from —COOX; —OX; —SX, —OR; —COOR, wherein X represent hydrogen or a cation and R represents a C₁ to C₂₀-alkyl, preferably a C₁ to C₁₂-alkyl.

The silicic compound preferably is selected from a divalent compound having one Si atom per molecule or a divalent compound being an open chain siloxane having 2 to 12 silicon atoms per molecule, or a cyclic siloxane having 3 to 12 silicon atoms per molecule, or a combination thereof. The remaining valences of said silicon atoms preferably are attached to an R radical wherein each R radical is selected independently from the group consisting of hydrogen, alkyl cycloalkyl, aryl aralkyl, alkaryl radicals having up to 20 carbon atoms wherein the radicals may, optionally, heterogroups connected to the carbon chain or the carbon ring selected from alkylamines and silylamines. Silicic compounds include the cyclosiloxanes, according to the formula

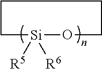

where R⁵ and R⁶ are the same or different and are each selected from H, a residue having from 1 to 20 carbon atoms, preferably selected from alkyl, cycloalkyl, aryl, alkaryl or aralkyl radical, wherein the radical may contain one or more heteroatoms, preferably O, N, S or Si, and preferably are selected from methyl. Specific examples include but are not limited to hexamethylcyclotrisiloxane, octamethylcyclotetrasiloxane, decamethylcyclopentasiloxane and dodecamethylcyclohexasiloxane, and mixtures of cyclosiloxanes of different ring sizes.

The cyclic urea preferably corresponds to the general formula

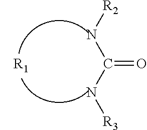

R₁ is selected from the group consisting of C₁-C₆-alkylenes that may be saturated or unsaturated and that may be unsubstituted or substituted by one more substituent, a C₆-C₁₁ arylene that may be unsubstituted or substituted by one or more substituent, wherein the substituents are selected from alkoxy groups and oxyalkyl groups having from 1 to 6 carbon atoms and —SiO(Rx)₃ groups wherein each Rx represents independently an alkyl with 1 to 6 carbon atoms. Preferably R1 is a C₁-C₃ alkylene, preferably unsubstituted and more preferably R₁ is —CH₂CH₂—. R₂, R₃ are identical or different and represent saturated or unsaturated organic radicals having from 1 to 24 carbon atoms and which may contain in addition to hydrogen one or more heteroatoms independently of one another selected from the group consisting of O, N, S and Si. For example, R2 and R3 may be selected from the group consisting of
(i) —C₁-C₂₄-alkyl, saturated or unsaturated, unsubstituted, mono- or polysubstituted; or
(ii) —C₁-C₂₄-heteroalkyl, saturated or unsaturated, unsubstituted, mono- or polysubstituted;
(iii) 6-24-membered aryl, unsubstituted, mono- or polysubstituted, wherein said 6-24-membered aryl is optionally connected through —C₁-C₆-alkylene- or —C₁-C₆-heteroalkylene-, in each case saturated or unsaturated, unsubstituted, mono- or polysubstituted;
(iv) 5-24-membered heteroaryl, unsubstituted, mono- or polysubstituted; wherein said 5-24-membered heteroaryl is optionally connected through —C₁-C₆-alkylene- or —C₁-C₆-heteroalkylene-, in each case saturated or unsaturated, unsubstituted, mono- or polysubstituted;
(v) 3-24-membered cycloalkyl, saturated or unsaturated, unsubstituted, mono- or polysubstituted; wherein said 3-24-membered cycloalkyl is optionally connected through —C₁-C₆-alkylene- or —C₁-C₆-heteroalkylene-, in each case saturated or unsaturated, unsubstituted, mono- or polysubstituted; and
(vi) 3-24-membered heterocycloalkyl, saturated or unsaturated, unsubstituted, mono- or polysubstituted; wherein said 3-24-membered heterocycloalkyl is optionally connected through —C₁-C₆-alkylene- or —C₁-C₆-heteroalkylene-, in each case saturated or unsaturated, unsubstituted, mono- or polysubstituted, wherein in each case “mono- or polysubstituted” means substituted with one or more substituents independently of one another selected C₁-C₁₈-alkyl which may be saturated or unsaturated and tri(C₁-C₁₈-)alkylsilyl. Preferably, R₂ and R₃ are selected from C₁-C₆-alkyl, more preferably from —CH₃ or —CH₂CH₃.

The reaction products may be treated with appropriate agents to introduce terminal units, for example least one terminal unit selected from —COOX; —OX; —SX, —OR; —COOR, wherein X represents hydrogen or a cation and R represents a C₁ to C₂₀-alkyl, preferably a C₁ to C₁₂-alkyl. Appropriate agents include but are not limited to acids, alcohols, thioalcohols and combinations thereof. Carboxylic acid groups can be introduced, for example by treatment with a silalactone-based functionalization agent or an anhydride-based agent. The treatment with a silactone-based or anhydride-based treatment may also be carried out by direct reaction with reactive polymer chains. The functionalization of polymers is described for example in WO2021/009154; U.S. Pat. Nos. 3,242,129, 4,020,036, 4,465,809, US2016/0075809 A1 and US2016/0083495 A1 and WO2021/009154, all incorporated herein by reference.

In one embodiment of the present disclosure there are provided compositions at least 90% by weight, preferably at least 95% by weight based on the total weight of the composition of ethylene-copolymer described above and conjugated diene polymer as described above. Preferably, such a composition is a solid composition. Such compositions may be obtained, for example, by mixing solid polymers (dry blending) or by adding another polymer to a polymer solution, preferably a reaction mixture and removing the solvent (wet blending).

The conjugated diene polymers may be oil-extended and may contain up to 100 parts per 100 parts of polymer of extender oil. In case the polymers are oil-extended, i.e., the polymers have been combined with one or more extender oil prior or during work up of the polymer, typically before solvent removal, the composition also contains extender-oil as part of the oil-extended polymers. Polymers may be oil-extended when they have a high molecular weight. Polymers with high molecular weight have high Mooney viscosities. When the Mooney viscosity is too high, processing the polymers for making rubber compounds may become difficult or uneconomic. The Money viscosity of the polymers can be reduced by adding extender oils prior or during the work up of the polymers to provide oil-extended polymers. Typical amounts of extender oils are from 10 to 100 parts per 100 parts of polymer. Extender oils include oils as known and used for the oil-extension of diene rubbers and include oils such as TDAE (Treated Distillate Aromatic Extract)-, MES (Mild Extraction Solvates)-, RAE (Residual Aromatic Extract)-, TRAE (Treated Residual Aromatic Extract)-, naphthenic oil, paraffinic oils and hydrogenated versions thereof including oils obtained from plant-based materials including terpenes. They are preferably added to the reaction mixture prior or during solvent removal.

### Rubber Compounds

The compositions comprising the polymers according to the present disclosure can be used to make rubber compounds by a process comprising combining the polymers with one or more filler and/or one or more cross-linking agent for cross-linking at least the conjugated diene polymer. The resulting tire or tire component will typically contain the conjugated diene polymer or rubber compound in vulcanized form.

Therefore, in one aspect of the present disclosure there is provided a process of making a rubber compound comprising combining a polymer composition according to the present disclosure with at least one filler, at least one curing agent capable of curing the at least diene polymer or a combination thereof.

The one or more filler includes both active and inactive fillers. Conventional fillers include silicas and, preferably, one or more than one carbon-based fillers, for example carbon blacks.

Specific examples of suitable fillers are described in US2016/0075809 A1 in [0061]-[0074], incorporated herein by reference. Preferably, the rubber compounds of the present disclosure contain one or more carbon blacks as fillers.

The fillers may be used in quantities ranging from 10 to 500, preferably from 20 to 200 parts by weight based on 100 parts by weight of rubber.

The rubber compounds and the vulcanizable rubber compounds may further contain one or more additional rubbers. Such additional rubbers include, for example, natural rubber and synthetic rubber, and in particular one or more polybutadiene rubbers, preferably Nd-catalyzed polybutadienes, also referred to as NdBRs. If present, they may be used in amounts in the range from 0.5 to 95% by weight, preferably in the range from 10 to 80% by weight, based on the total amount of rubber in the composition. Examples of suitable synthetic rubbers include those described in US2016/0075809 A1 in [0060], incorporated herein by reference.

The composition may further comprise one or more rubber additives. Rubber additives are ingredients that may improve the processing properties of the rubber compositions, facilitate or accelerate crosslinking, improve the physical properties of the vulcanizates produced from the rubber, improve the interaction between the rubber and the filler or serve to bond the rubber to the filler. Rubber auxiliaries include crosslinking agents such as sulfur or sulfur-supplying compounds, reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators. The total amount of rubber additives, including curing agents such as sulfur or sulfur-supplying compounds, may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

Preferably, the ethylene-copolymer provided herein, more preferably the compositions comprising at least one of the ethylene-copolymers and at least one of the conjugated diene polymers, are used, preferably as components of a curable composition, for making tires or tire treads.

Therefore, in one aspect there is provided an article obtained from curing a composition comprising the polymers according to the present disclosure. The process may comprise at least one shaping step wherein the shaping may take place prior to, during or after the curing. Suitable articles include tires, preferably tire treads. However, the compositions containing the polymers provided herein are also suitable for the manufacture of articles, in particular molded articles, for example for the manufacture of cable sheaths, hoses, drive belts, conveyor belts, roll linings, shoe soles, sealing rings and damping elements.

The following examples are provided to further illustrate the present disclosure without, however, intending to limit the disclosure to the embodiments set forth in these examples.

### Methods

### Molecular Weights

The molecular weight of the polymer (Mw and Mn, respectively the weight average and the number average molecular weight momenta) were determined by gel permeation chromatography. Universal calibration of the system was performed with polyethylene (PE) standards. A Polymer Char GPC from Polymer Characterisation S.A. Valencia, Spain was used. The Size Exclusion Chromatograph was equipped with an on-line viscometer (Polymer CharV-400 Viscometer), an online infrared detector (IR5 MCT), 3 AGILENT PL OLEXIS columns (7.5×300 mm) and a Polymer Char autosampler.

The polymer samples were weighted (in the concentration range of 0.3 to 1.3 mg/ml) into the vials of the PolymerChar autosampler. In the autosampler the vials were filled automatically with solvent (1,2,4-tri-chlorobenzene, TCB) stabilised with 1 g/l di-tert-butyl-paracresol (DBPC). The samples were kept in the high temperature oven (160° C.) for 4 hours. After this dissolution time, the samples were automatically filtered by an in-line filter before being injected onto the columns. The chromatograph system was operated at 160° C. The flow rate of the TCB eluent was 1.0 ml/min. The chromatograph contained a built-in on-line infrared detector (IR5 MCT) for concentration and a built-in PolymerChar on-line viscometer.

### Properties of Vulcanized Compounds

The loss factors tan δ were measured at 0° C. and at 60° C. to determine the temperature-dependent dynamic-mechanical properties. An EPLEXOR device (Eplexor 500 N) from GABO was used for this purpose. The measurements were carried out in accordance with DIN 53513 at 10 Hz on Ares strips in the temperature range from −100° C. to 100° C.

Rebound resilience at 60° C. was determined according to DIN 53512.

Tensile strength tests were performed on the vulcanized S2 test specimens according to DIN 53504.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (2 samples each 20×6 mm, pre-compressed to 5 mm thickness) and a measurement frequency of 10 Hz in the strain range from 0.1 to 40%. The method was used to obtain the following properties:

G′ (0.5%): dynamic modulus at 0.5% amplitude sweep, G′ (15%): dynamic modulus at 15% amplitude sweep, G′=G′ (0.5%)−G′ (15%): difference of dynamic modulus at 0.5% relative to 15% amplitude sweep, tan δ (max): maximum loss factor (G″/G′) of entire measuring range at 60° C.

The difference of G′ (0.5%)−G′ (15%) is an indication of the Payne effect of the mixture. The lower the value the better the distribution of the filler in the mixture, the better the rubber-filler interaction and the lower the risk of phase separation.

### Examples

Three different non-conjugated diene polymers (polymers 1, 2 and 3) were mixed with different conjugated dienes rubbers in a tire tread formulation and subjected to curing. The tire tread compositions are summarized in table 1. Polymer 1 was a non-functionalized EPM rubber (49 wt. % C2, Mn 57 kg/mol, Mw 125 kg/mol), polymer 2 was a non-functionalized EPDM rubber (7.8 wt % ENB, 49 wt. % C2, Mn 45 kg/mol, Mw 170 kg/mol) and polymer 3 was a functionalized EPM (1.9% wt. of grafted maleic acid anhydride, 49 wt. % C2, Mn 50 kg/mol, Mw 100 kg/mol, MFI 4.5 g/10 min). The conjugated dienes rubbers were a non-functionalized polybutadiene (BR), a non-functionalized styrene-butadiene copolymers (SSBR) and a styrene-butadiene copolymer (FxSSBR) functionalized to have a terminal, polar siloxane-units comprising end group.

TABLE 1
Compound recipes. Values are shown in phr units.

| | C1a | C1b | C1c | Ex1 | C2a | C2b | C2c | Ex2 |
|---|---|---|---|---|---|---|---|---|
| SSBR | 96.26 | 82.5 | 82.5 | 82.5 | | | | |
| Fx-SSBR | | | | | 73.5 | 63 | 63 | 63 |
| Polymer 1 | | 10 | | | | 10 | | |
| Polymer 2 | | | 10 | | | | 10 | |
| Polymer 3 | | | | 10 | | | | 10 |
| BR | 30 | 30 | 30 | 30 | 30 | 30 | 30 | 30 |
| silica | 90 | 90 | 90 | 90 | 90 | 90 | 90 | 90 |
| carbon black | 5 | 5 | 5 | 5 | 5 | 5 | 5 | 5 |
| TDAE oil | 4.75 | 8.5 | 8.5 | 8.5 | 27.5 | 28 | 28 | 28 |
| AFLUX 37 | 3 | 3 | 3 | 3 | 3 | 3 | 3 | 3 |
| 6-PPD | 2 | 2 | 2 | 2 | 2 | 2 | 2 | 2 |
| VULCANOX | 2 | 2 | 2 | 2 | 2 | 2 | 2 | 2 |
| H5 LG | | | | | | | | |
| Wax | 2 | 2 | 2 | 2 | 2 | 2 | 2 | 2 |
| Silane | 2 | 2 | 2 | 2 | 2 | 2 | 2 | 2 |
| Sulfur | 1.7 | 1.7 | 1.7 | 1.7 | 1.7 | 1.7 | 1.7 | 1.7 |
| ZnO | 3.75 | 3.75 | 3.75 | 3.75 | 3.75 | 3.75 | 3.75 | 3.75 |
| stearic acid | 1 | 1 | 1 | 1 | 1 | 1 | 1 | 1 |
| RHENOGRAN | 2.5 | 2.5 | 2.5 | 2.5 | 2.5 | 2.5 | 2.5 | 2.5 |
| DPG 80 | | | | | | | | |
| RHENOGRAN | 2 | 2 | 2 | 2 | 2 | 2 | 2 | 2 |
| TBBS 80 | | | | | | | | |

SSBR = BUNA VSL 4526-2 HM = styrene-butadiene copolymer, available from ARLANXEO Deutschland GmbH;
FxSSBR = functionalized styrene-butadiene copolymer (50% vinyl and 21% styrene, 5 phr TDAE oil) prepared according to US2016075809 A1; BR = BUNA CB24 = polybutadiene rubber, available from ARLANXEO Deutschland GmbH.

In a first step the following ingredients were mixed in a 1.5 L kneader. Polymers were added first, after 30 s of mixing ⅔ of the silica, ⅔ of the silane, stabilizers and stearic acid were added. After 90 s the remaining silica and silane were added together with oil and carbon black. After 150s of mixing zinc oxide is added and after 210 s of mixing the mixer is heated to 150° C. and held at this temperature for 3 minutes. The resulting mixture is then milled on a roller mill (3 times I/r cross cutting and folding, 3 times end roll (4 mm)). The resulting mixture is allowed to rest for 24 h and is then added to the 1.5 L kneader at 150° C. and mixed for 3 min at 150° C. The resulting mixture is milled on the roller mill again (3×r/l cross cutting and folding (4 mm)). Sulfur and accelerators are added to the roller mill and milling is continued (3×r/l cross cutting and folding, 5× end roll (4 mm)). The tire tread composition was then subjected to curing at 160° C. for 1560 s.

TABLE 2
Compound properties

| | C1a | C1b | C1c | Ex1 | C2a | C2b | C2c | Ex2 |
|---|---|---|---|---|---|---|---|---|
| tan delta | 0.113 | 0.127 | 0.133 | 0.102 | 0.99 | 0.113 | 0.11 | 0.09 |
| at 60° C. | | | | | | | | |
| Rebound | 55 | 52 | 53.5 | 58.5 | 56.5 | 54.33 | 56 | 60 |
| at 60° C. | | | | | | | | |
| [%] | | | | | | | | |
| tan delta | 0.174 | 0.182 | 0.195 | 0.148 | 0.152 | 0.165 | 0.173 | 0.137 |
| maximum | | | | | | | | |
| Payne | 1.67 | 1.74 | 2.15 | 1.51 | 1.31 | 1.44 | 1.50 | 1.12 |
| effect | | | | | | | | |
| [MPa] | | | | | | | | |
| Tensile | 23.5 | 19.9 | 20.6 | 22.8 | 22.6 | 17.6 | 21 | 22.5 |
| strength | | | | | | | | |
| [MPa] | | | | | | | | |

The results show that the addition of the functionalized ethylene copolymer (polymer 3) to butadiene or styrene-butadiene polymers led to a better filler dispersion (the values for the Payne effect (G′ (0.5%)−G′ (15%) decreased) and to improved rolling resistance indicators (the values for tan delta 60° C. and tan delta max decreased and the values for rebound 60° C. increased).

1. A method comprising making a tire or a tire tread compound from an ethylene copolymer, wherein the ethylene-copolymer is a copolymer comprising units derived from ethylene and at least one alpha-olefin monomer having from 3 to 12 carbon atoms and, optionally, having units derived from at least one non-conjugated diene, and wherein the ethylene copolymer is functionalized to have at least one functional group comprising at least one polar unit selected from a carboxylic acid group or a salt thereof, an anhydride group, an epoxy group, a glycidyl ether group, or a combination thereof, and wherein the ethylene-copolymer comprises from 40 to 80% wt. of units derived from ethylene and at least 20% wt. of units derived from one or more alpha-olefin monomers having from 3 to 12 carbon atoms.

2. The method according to claim 1, wherein the ethylene copolymer comprises from 0.001 to 20% by weight, based on a weight of the polymer, of the one or more polar units.

3. The method according to claim 1, wherein the polar unit is selected from a monocarboxylic acid group or a salt thereof, a bicarboxylic acid group or a salt thereof, an anhydride group, or a combination thereof.

4. The method according to claim 1, wherein the one or more functional groups of the ethylene-copolymer are derived from at least one olefinic functionalizing agent selected from glycidylmethacrylate, allyl glycidyl ether, allyl glycidyl ester, acrylic acid, methacrylic acid, vinyl acetate, cinnamic acid, crotonic acid, maleic acid, fumaric acid, itaconic acid, citraconic acid, glutaconic acid, maleic anhydride, itaconic anhydride, citraconic anhydride, glutaconic anhydride including salts thereof and derivatives thereof where one or more hydrocarbon groups bear a substituent instead of a hydrogen atom and wherein the substituent is selected from a halogen, a C₁-C₆ alkyl, a C₁-C₆ halogenated alkyl, a C₂-C₆ alkenyl, a C₂-C₆ halogenated alkenyl, a C₁-C₆ hydroxy alkyl, a C₂-C₆ hydroxy alkenyl, a C₁-C₆ alkyl ether or a C₂-C₆ alkenylether or polyether.

5. The method according to claim 1, wherein the ethylene-copolymer has one or more functional groups according to formulae (1), (2) or a combination thereof: 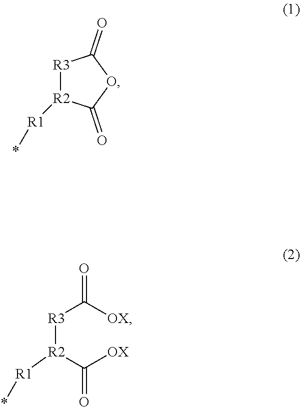
wherein in formula (1) R1 represents a chemical bond or a C₁-C₆ alkyl, a C₁-C₆ halogenated alkyl, a C₁-C₆ hydroxy alkyl, a C₁-C₆ alkyl ether or polyether, R2 represents a —CH₂— group of which one hydrogen atom, optionally, may be substituted with a halogen, a C₁-C₆ alkyl, a C₁-C₆ halogenated alkyl, a C₁-C₆ hydroxy alkyl, a C₁-C₆ alkyl ether or polyether, R3 is a —CH₂— group of which one hydrogen atom, optionally, may be substituted with a halogen, a C₁-C₆ alkyl, a C₁-C₆ halogenated alkyl, a C₁-C₆ hydroxy alkyl, a C₁-C₆ alkyl ether or polyether, and wherein the * indicates the connection to the polymer backbone and wherein X represents H or a cation.

6. The method according to claim 1, wherein the ethylene-copolymer has a melt flow index at 190° C. and 2.16 kg load of from 0.5 to 110 g/10 min.

7. The method according to claim 1, wherein the functional group of the ethylene-copolymer is obtainable by grafting at least one olefinic functionalization agent onto an ethylene-copolymer to provide the ethylene-copolymer, or by copolymerizing at least one functionalization agent during the polymerization reaction to produce the ethylene-copolymer, or by a combination thereof.

8. A composition comprising (i) at least one functionalized ethylene-copolymer, and (ii) at least one conjugated diene polymer, wherein the ethylene-copolymer is a copolymer comprising units derived from ethylene and at least one alpha-olefin monomer having from 3 to 12 carbon atoms and, optionally, having units derived from at least one non-conjugated diene, and wherein the ethylene copolymer is functionalized to have at least one functional group comprising at least one polar unit selected from a carboxylic acid group or a salt thereof, an anhydride group, an epoxy group, a glycidyl ether group, or a combination thereof, and wherein the ethylene-copolymer comprises from 40 to 80% wt. of units derived from ethylene and at least 20% wt. of units derived from one or more alpha-olefin monomers having from 3 to 12 carbon atoms, wherein the conjugated diene polymer is a homopolymer of a conjugated diene or a copolymer of at least one conjugated diene, and wherein the conjugated diene is selected from the group consisting of butadiene, isoprene, 1,3-pentadiene, 2,3-dimethylbutadiene, 1-phenyl-1,3-butadiene, 1,3-hexadiene, preferably butadiene, and wherein the conjugated diene polymer is either non-functionalized or functionalized.

9. The composition according to claim 8, wherein the conjugated diene polymer is a butadiene homopolymer or copolymer comprising units derived from butadiene and at least one other conjugated diene or at least one vinyl aromatic comonomer or a combination thereof, and, wherein the vinyl aromatic comonomer is selected from styrene, ortho-methyl styrene, meta-methyl styrene, para-methyl styrene, para-tertbutyl styrene, vinyl naphthalene, and combinations thereof.

10. The composition according to claim 8, wherein the conjugated diene polymer is functionalized and comprises at least one functional group comprising at least one siloxane unit, which, optionally, comprises one or more heteroatoms selected from N and S.

11. The composition according to claim 8, wherein the conjugated diene polymer is functionalized with at least one functional group that comprises at least one terminal unit comprising at least one group selected from the groups —COOX; —OX; —SX, —OR; —COOR, wherein X represents hydrogen or a cation and R represents a C₁ to C₂₀-alkyl.

12. The composition according to claim 8, wherein the weight ratio of the ethylene copolymer and conjugated diene polymer is from of 1:2 to 1:20.

13. A method of making a curable composition comprising combining an ethylene-copolymer with a conjugated diene polymer and at least one curative capable of curing at least the conjugated diene polymer, wherein the ethylene-copolymer is a copolymer comprising units derived from ethylene and at least one alpha-olefin monomer having from 3 to 12 carbon atoms and, optionally, having units derived from at least one non-conjugated diene, and wherein the ethylene copolymer is functionalized to have at least one functional group comprising at least one polar unit selected from a carboxylic acid group or a salt thereof, an anhydride group, an epoxy group, a glycidyl ether group, or a combination thereof, and wherein the ethylene-copolymer comprises from 40 to 80% wt. of units derived from ethylene and at least 20% wt. of units derived from one or more alpha-olefin monomers having from 3 to 12 carbon atoms.

14. An article obtained by a process comprising curing a composition comprising the composition of claim 8, and wherein the process comprises at least one shaping step wherein the shaping may take place prior to, during or after the curing.

15. The article of claim 14, selected from a tire or a tire tread of a tire.
